(19) United States
(12) Patent Application Publication
(10) Pub. No.: US 2007/0213941 A1
(43) Pub. Date: Sep. 13, 2007

(54) Techniques to reduce power consumption in mobile devices

(76) Inventors: Levy Schmuel, Tivon (IL); Shay Waxman, Haifa (IL)

Correspondence Address: INTEL CORPORATION;c/o INTELLEVATE, LLC, P.O. BOX 52050, MINNEAPOLIS, MN, 55402, US

(21) Appl. No.: 11/375,471

(22) Filed: Mar. 13, 2006

(51) Int. Cl. G06F 19/00

(52) U.S. Cl. 702/32; 375/247

(57) ABSTRACT

An embodiment of the present invention provides an apparatus, comprising a mobile device operable to communicate in a wireless network, wherein the mobile device may use a multi-mode resolution digital signal processor (DSP) with one mode operable at a lower bit resolution and lower power consumption and a second mode at a second resolution for higher bit resolution with higher power consumption. In an embodiment of the present invention, the lower bit resolution may be a 4 bit DSP capable of being used for packet header decoding and a PHY rate may be decoded from the packet header to determine which resolution mode to use.

### BACKGROUND

Wireless networks have grown increasingly in importance and have varying uses. One of the main differentiators between wireless platforms, especially mobile devices, is their power consumption and concomitant battery life. The power consumption may be measured in different modes of operation and usage models. Digital signal processor (DSP) power reduction techniques have not been attempted to date as the potential savings from such technique was considered to be much lower than the potential savings lying in analog power reduction techniques.

Thus, a strong need exists for DSP power reduction techniques to reduce power consumption in mobile devices.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a low power DSP architecture block diagram of one embodiment of the present invention;

FIG. 2 illustrates a flowchart of the method of one embodiment of the present invention; and

FIG. 3 depicts a mobile device as used in a wireless local area network (WLAN) of one embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

An algorithm, technique or process is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein. In addition, it should be understood that operations, capabilities, and features described herein may be implemented with any combination of hardware (discrete or integrated circuits) and software.

as in a cause and effect relationship).

It should be understood that embodiments of the present invention may be used in a variety of applications. Although the present invention is not limited in this respect, the devices disclosed herein may be used in many apparatuses such as in the transmitters and receivers of a radio system. Radio systems intended to be included within the scope of the present invention include, by way of example only, cellular radiotelephone communication systems, satellite communication systems, two-way radio communication systems, one-way pagers, two-way pagers, personal communication systems (PCS), personal digital assistants (PDA's), wireless local area networks (WLAN), personal area networks (PAN, and the like), wireless wide are networks (WWAN) and Mesh networks.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause and effect relationship).

In today's sophisticated wireless networks, such as, but not limited to, 802.16 or 802.11n, mobile devices may use large ASICs and ASICs which may vary greatly in power consumption. Thus, by focusing on the power required by these ASICs, significant power savings may be accomplished.

Unlike analog power reduction schemes where it is sometimes sufficient to simply reduce current, the DSP is designed in such way that it has fixed effective number of bits (ENOB) such that its evaluation model (EVM) exceeds a certain figure required by a standard (for example, in 802.11a an EVM higher than 25 dB is required for reaching the highest 54 Mbps rate. Reaching such EVM requires the DSP to have ˜8 bit resolution starting from the A/D converter up to the demapper in RX; or in TX, from mapper up to D/A converter). An embodiment of the present invention, optimizes, for example, but not limited to, 802.11/802.16 DSP power consumption using a 2-mode resolution DSP. It is understood that various modes of resolution and various wireless network standards are intended to be within the scope of the present invention.

In an embodiment of the present invention, instead of having a single high resolution DSP required for high-end 802.11/802.16 operation, multiple DSPs (such as two) may be utilized: one with the high-resolution; and the other, much smaller, with the number of bits required for basic binary phase-shift keying (BPSK) and quadrature phase shift keying (QPSK) operation.

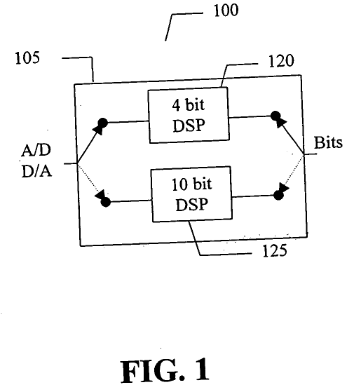

Turning now to the figures, FIG. 1, generally at 100, illustrates a 10 bit DSP 125 and 4 bit DSP 120 of an embodiment of the present invention. The added gate-count in this embodiment is only ˜20% due to the additional 4 bit DSP 120. The potential gain in power consumption is, in WLAN RX for example, 40 mW (10 mW instead of 50 mW) using P874, or equivalently ˜80%.

The selection of which of the DSP to use in a receiver 105 may be done on the fly based on the PHY rate decoded from the packet header. Packet header decoding may be done using the smaller DSP. If the rate is QAM-16/QAM-64 rate, the signal may be processed using the 10 bit DSP 125, otherwise, it is processed using the 4-bit DSP 120 (again, a 10 bit and a 4 bit DSP are merely an example of possible multiple DSPs). In addition, by separating power supplies, the idle DSP may be shut down and effectively have no impact on the power consumption.

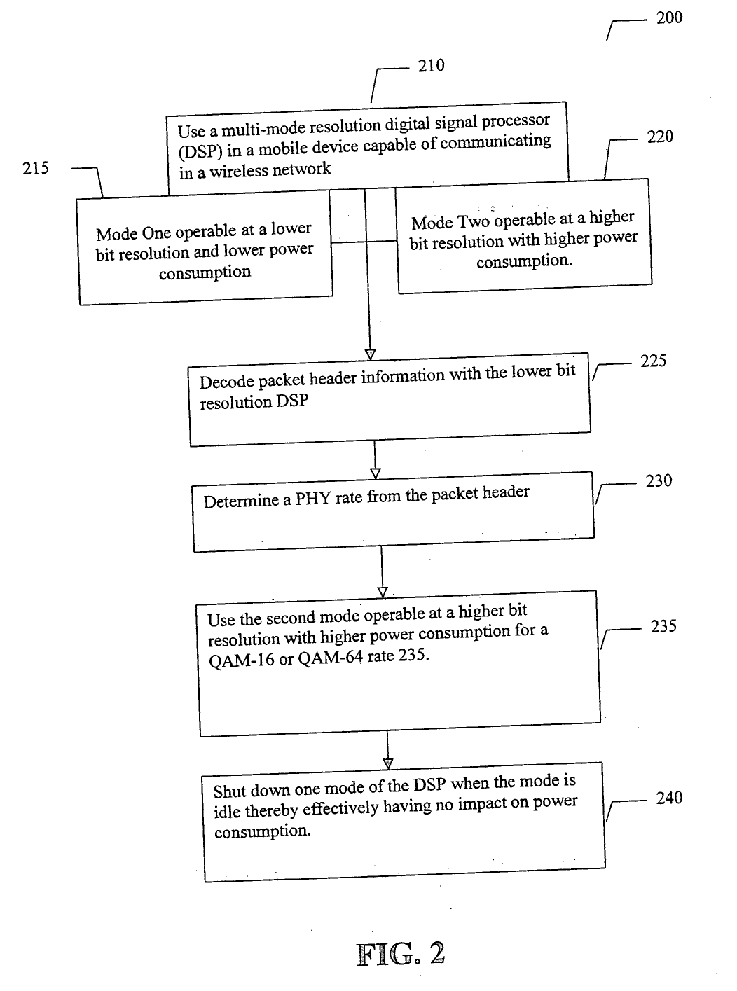

Turning now to FIG. 2, at 200, is an illustration of the method of an embodiment of the present invention which comprises using a multi-mode resolution digital signal processor (DSP) in a mobile device capable of communicating in a wireless network 210, with one mode operable at a lower bit resolution and lower power consumption 215 and a second mode operable at a higher bit resolution with higher power consumption 220. The present method may further comprise decoding packet header information with the lower bit resolution DSP 225 and determining a PHY rate from the packet header 230. Also, the present method may further comprise using the second mode operable at a higher bit resolution with higher power consumption for a QAM-16 or QAM-64 rate 235. It is also possible in an embodiment of the present method to further comprise shutting down one mode of the DSP when the mode is idle 240, thereby effectively having no impact on power consumption.

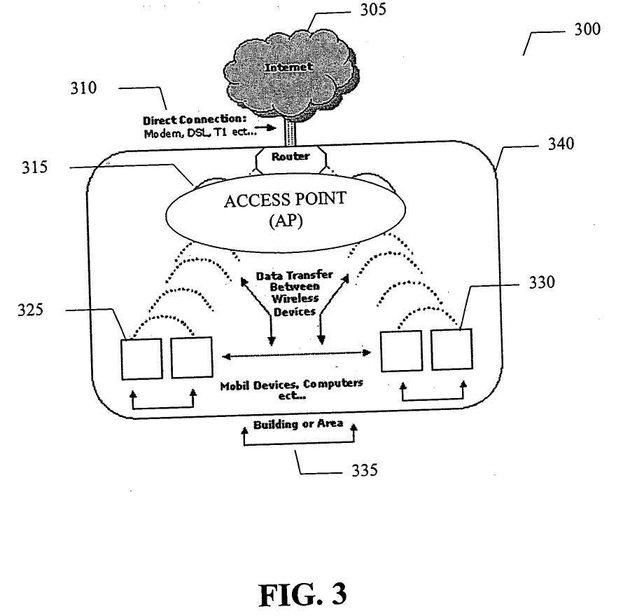

Turning now to FIG. 3, at 300, is illustrated another embodiment of the present invention which provides system, comprising a first digital signal processor (DSP) connected to a mobile device (325 or 330) operable to communicate in a wireless network 340 that may be located in a specific area or building 335; a second digital processor (DSP) connected to the mobile device (325 or 330), wherein the second DSP operates at a higher resolution and higher power consumption than the first DSP and wherein the mobile device is capable of switching between the first DSP and the second DSP depending on resolution requirements of the mobile device. The first DSP may be, for example but not limited to, a 4 bit DSP and the 4 bit DSP may be capable of being used for packet header decoding and wherein a PHY rate is decoded from the packet header to determine which of the first or the second DSP to use. Further, the second DSP may be, for example, but not limited to, a 10 bit DSP used if a data rate is a QAM-16 or QAM-64 rate. The mobile devices may be in communication with access point 315, which may be connected to the Internet 305 via, for example, a T-1 line.

Yet another embodiment of the present invention provides a machine-accessible medium that provides instructions, which when accessed, cause a machine to perform operations comprising controlling a multi-mode resolution digital signal processor (DSP) in a mobile device capable of communicating in a wireless network, with one mode operable at a lower bit resolution and lower power consumption and a second mode operable at a higher bit resolution with higher power consumption. Again, there is no limit to the number of modes possible for the DSP. The machine-accessible medium of one embodiment of the present invention may further comprise the instructions causing the machine to perform operations further comprising decoding packet header information with the lower bit resolution DSP and determining a PHY rate from the packet header.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. An apparatus, comprising:
a mobile device operable to communicate in a wireless network, wherein said mobile device comprises a plurality of digital signal processors (DSPs) with at least one of said plurality of DSPs operable at a reduced power level for less demanding digital processing.

2. The apparatus of claim 1, wherein said wireless network is an Electrical and Electronic Engineers (IEEE) 802.11 standard wireless network.

3. The apparatus of claim 1, wherein said at least one DSP operable at a reduced power level is a 4 bit DSP.

4. The apparatus of claim 3, wherein said 4 bit DSP is capable of being used for packet header decoding and wherein a PHY rate is decoded from said packet header to determine which of said plurality of DSPs to use.

5. The apparatus of claim 1, wherein at least one of said plurality of DSPs is a 10 bit DSP and used if a data rate is a QAM-16 or QAM-64 rate.

6. The apparatus of claim 1, wherein if one of said plurality of DSPs is idle, said idle DSP is capable of being be shut down thereby effectively having no impact on power consumption.

7. An apparatus, comprising:
a mobile device operable to communicate in a wireless network, wherein said mobile device uses a multi-mode resolution digital signal processor (DSP) with one mode operable at a lower bit resolution and lower power consumption and a second mode at second resolution for higher bit resolution with higher power consumption.

8. The apparatus of claim 7, wherein said lower bit resolution is a 4 bit DSP capable of being used for packet header decoding and wherein a PHY rate is decoded from said packet header to determine which resolution mode to use.

9. The apparatus of claim 7, wherein said higher bit resolution DSP is a 10 bit DSP used if a data rate is a QAM-16 or QAM-64 rate.

10. A method, comprising:
using a multi-mode resolution digital signal processor (DSP) in a mobile device capable of communicating in a wireless network, with one mode operable at a lower bit resolution and lower power consumption and a second mode operable at a higher bit resolution with higher power consumption.

11. The method of claim 10, further comprising decoding packet header information with said lower bit resolution DSP and determining a PHY rate from said packet header.

12. The method of claim 10, further comprising using said second mode operable at a higher bit resolution with higher power consumption for a QAM-16 or QAM-64 rate.

13. The method of claim 10, further comprising shutting down one mode of said DSP when said mode is idle, thereby effectively having no impact on power consumption.

14. A machine-accessible medium that provides instructions, which when accessed, cause a machine to perform operations comprising:
controlling a multi-mode resolution digital signal processor (DSP) in a mobile device capable of communicating in a wireless network, with one mode operable at a lower bit resolution and lower power consumption and a second mode operable at a higher bit resolution with higher power consumption.

15. The machine-accessible medium of claim 14, further comprising said instructions causing said machine to perform operations further comprising decoding packet header information with said lower bit resolution DSP and determining a PHY rate from said packet header.

16. The machine-accessible medium of claim 14, further comprising said instructions causing said machine to perform operations further comprising using said second mode operable at a higher bit resolution with higher power consumption for a QAM-16 or QAM-64 rate.

17. The machine-accessible medium of claim 14, further comprising said instructions causing said machine to perform operations further comprising shutting down one mode of said DSP when said mode is idle, thereby effectively having no impact on power consumption.

18. A system, comprising:
a first digital signal processor (DSP) connected to a mobile device operable to communicate in a wireless network;
a second digital processor (DSP) connected to said mobile device, wherein said second DSP operates at a higher resolution and higher power consumption than said first DSP and wherein said mobile device is capable of switching between said first DSP and said second DSP depending on resolution requirements of said mobile device.

19. The system of claim 18, wherein said first DSP is a 4 bit DSP.

20. The system of claim 19, wherein said 4 bit DSP is capable of being used for packet header decoding and wherein a PHY rate is decoded from said packet header to determine which of said first or said second DSP to use.

21. The system of claim 18, wherein said second DSP is a 10 bit DSP used if a data rate is a QAM-16 or QAM-64 rate.

22. The system of claim 18, wherein if said first or said second DSP is idle, said idle DSP is capable of being be shut down thereby effectively having no impact on power consumption.
